(19) United States
(12) Patent Application Publication
(10) Pub. No.: US 2024/0281375 A1
(43) Pub. Date: Aug. 22, 2024

(54) TECHNOLOGIES TO EXPAND PIN COUNT

(71) Applicant: Intel Corporation, Santa Clara, CA (US)

(72) Inventors: Ramamurthy KRITHIVAS, Gilbert, AZ (US); Yi ZENG, Shanghai (CN); Rahul SHAH, Marlborough, MA (US); Krzysztof WOJCIK, Czeczewo (PL)

(21) Appl. No.: 18/651,039

(22) Filed: Apr. 30, 2024

(30) Foreign Application Priority Data
Dec. 16, 2023 (WO) PCT/CN2023/139318

(51) Int. Cl. G06F 12/08

(52) U.S. Cl. CPC G06F 12/08; G06F 2212/16

(57) ABSTRACT

Examples described herein relate to communications with a bootable processor. Some examples include allocating memory address space to provide access to communications over general purpose input output (GPIO)-consistent pins, wherein the GPIO-consistent pins comprise pins coupled to the bootable processor and a pin of the pins coupled to the bootable processor receives or transmits communication for multiple platform GPIO pins.

### RELATED APPLICATION

This application claims the benefit of priority to Patent Cooperation Treaty (PCT) Application No. PCT/CN2023/139318, filed Dec. 16, 2023. The entire content of that application is incorporated by reference in its entirety.

### BACKGROUND

Some computer systems utilize a chipset architecture that include a central processing unit (CPU) coupled to a Platform Controller Hub (PCH). The PCH provides General Purpose Input Output (GPIO) used by platform devices to communicate with software executed by the CPU. Bootable CPUs are a class of CPUs that remove a PCH and integrate boot, early reset, power management, and IOs of the PCH into the CPU complex.

### BRIEF DESCRIPTION OF THE DRAWINGS

FIG. 1 depicts an example system.

FIG. 2 depicts an example system.

FIG. 3 depicts an example of register access.

FIG. 4 depicts an example process.

FIG. 5 depicts an example system.

### DETAILED DESCRIPTION

CPUs and bootable CPUs utilize pins to receive communications that include, at least: interrupts, time stamps, read requests, write requests, status, or others. GPIO supports communications of at least: read (status), write (bit-bang), and event (interrupts). However, increasing a number of pins (e.g., GPIO pins) can increase package cost. Accordingly, some CPUs and bootable CPUs have a limited number of pins. Despite a limited number of IO pins, various examples can increase a number of available pins to increase bandwidth of communications and types of communications made over the available pins. For example, a CPU can communicate over native GPIO pins and also virtual wire-based Enhanced Serial Peripheral Interface (eSPI) communications through platform GPIO pads. Platform GPIO pads can communicate with circuitry (e.g., an expander device) that can expand a number of additional GPIO pins by communication through eSPI virtual wires, and the circuitry can connect to the CPU via an eSPI interface (I/F).

An Advanced Configuration and Power Interface (ACPI) infrastructure can be used for reset and power management of a CPU and also to read/write GPIOs. To provide communications with the CPU, various examples can flexibly partition an ACPI register infrastructure (e.g., GPIO Read/Write/Status-Enable indication) and ACPI eventing and status interface among the native GPIO pads and platform GPIO pads. eSPI virtual wires communicated over one or more platform GPIO pads can share the ACPI register infrastructure with communications over native GPIO pads. An operating system (OS) can access communications received from native and platform GPIO pads and issue communications to native and platform GPIO pads by an application programming interface (API) call to access a register in Advanced Configuration and Power Interface (ACPI) infrastructure-owned mode.

In some examples, software (e.g., boot firmware) can select a number of bits and bit-offset in an ACPI register infrastructure to map to a native and platform GPIO pads. Circuitry (e.g., multiplexer) can route communications from a GPIO pin to the ACPI register infrastructure. Accordingly, GPIO read, write, or event indications, and other communications, over native and platform GPIO pads can be accessed by a single software infrastructure.

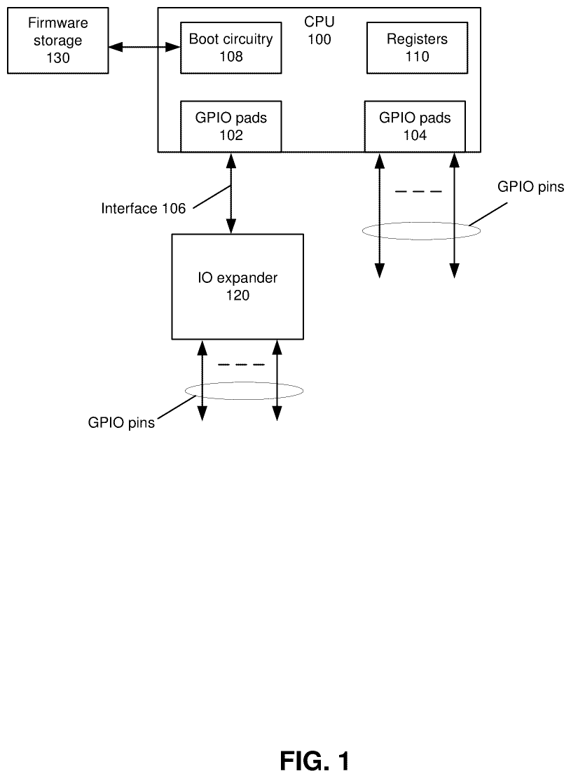

FIG. 1 depicts an example system. Bootable CPU 100 can receive and transmit signals at least through GPIO pads 102 and 104. GPIO pads 102 and 104 can be conductively coupled to GPIO pins. As described herein, IO expander 120 can increase a number of GPIO pins that can communicate with GPIO pads 102 beyond a number of pads in GPIO pads 102. For example, where there are X number of GPIO pads 102, IO expander 120 can provide and receive communications from X*Y GPIO pins to and from GPIO pads 102, where X and Y are integers. IO expander 120 can communicate with GPIO pads 102 via an interface 106 using communications consistent at least with Serial Peripheral Interface (SPI), eSPI, SMBus, or others.

While not shown, various devices can be coupled to GPIO pins 212 and 214, including flash memory, storage, a processor, a microcontroller, an accelerator, a network interface device, or other circuitry.

CPU 100 can utilize an architecture that includes boot hardware/firmware (HW/FW) circuitry 108 to enable CPU 100 to boot by loading boot firmware from a firmware storage device 130, as opposed to employing a legacy PCH to access the firmware storage device. Bootable HW/FW circuitry 108 can manage loading and execution of the firmware to boot CPU 100 and an associated platform.

As described herein, various examples can flexibly partition at least one of registers 110 for GPIO Read, Write, or Status-Enable indications for communications to and from platform GPIO pads 102 and native GPIO pads 104. As described herein, software (e.g., boot firmware) can select a number of bits and bit-offset in an ACPI register of registers 110 for communications with platform GPIO pads 102 and native GPIO pads 104.

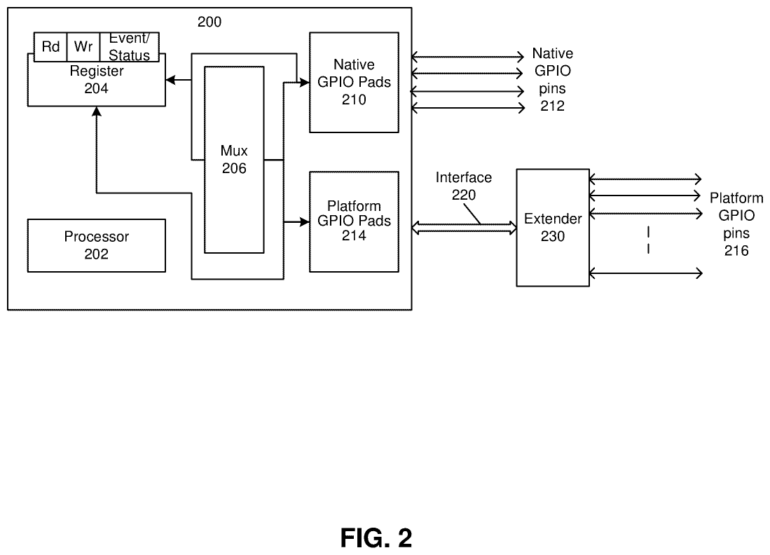

FIG. 2 depicts an example system. System 200 can include a processor socket that includes processor 202. Processor 202 can include one or more of: a central processing unit (CPU), a processor core, graphics processing unit (GPU), field programmable gate array (FPGA), application specific integrated circuit (ASIC), or other circuitry. A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

A system agent can include a shared cache which may include any type of cache (e.g., level 1, level 2, or last level cache (LLC)). A system agent can include or more of: a memory controller, a shared cache, a cache coherency manager, arithmetic logic units, floating point units, core or processor interconnects, or bus or link controllers. A system agent or uncore can provide one or more of: direct memory access (DMA) engine connection, non-cached coherent master connection, data cache coherency between cores and arbitrate cache requests, or Advanced Microcontroller Bus Architecture (AMBA) capabilities. System agent or uncore can manage priorities and clock speeds for receive and transmit fabrics and memory controllers.

System 200 can provide an interface to native GPIO pins 212 and interface to platform GPIO pins 214. For example, native GPIO pads 210 can be conductively coupled to native GPIO pins 212 whereas platform GPIO pads 214 can be conductively coupled to platform GPIO pins 216.

To increase number of pins accessible through platform GPIO pads 214, extender 230 can virtualize communications via platform GPIO pins 216. For example, extender 230 can send packets (e.g., headers and payloads) via interface 220 (e.g., SPI, eSPI, SMBus, or others) to platform GPIO pads 214 or send packets from platform GPIO pads 214, via interface 220, to platform GPIO pins 216. Extender 230 can be implemented as one or more of: an FPGA, ASIC, microcontroller, processor, or other circuitry.

Extender 230 can transmit packets to platform GPIO pads 214 or receive packets from platform GPIO pads 214. To virtualize communications, extender 230 can multiplex signals to and from GPIO pins 214. Multiplexing can include time domain multiplexing, wave division multiplex, or others. For example, time slot 0 can be allocated to communications (transmit or receive) with platform GPIO pin 0, time slot 1 can be allocated to communications with platform GPIO pin 1, and so forth. Accordingly, for N number of platform GPIO pads 212, extender 230 can increase a number of platform GPIO pins 214 that can receive communications and transmit communications to N*M.

Register 204 can be configured so that specific ranges of event/status indications are allocated to native or platform GPIO pins. For example, a boot firmware (e.g., Basic Input/Output System (BIOS), Universal Extensible Firmware Interface (UEFI), or a boot loader) can program a pad in register 204 for a GPIO pin as ACPI-owned and the GPIO type, read (Rd), write (Wr), or event and status registers to support events. Multiplexer 206 can be configured to route communications from the native or platform GPIO pins to a specific bit offset for an Event/Status register pair in the ACPI register 204. For example, bits [b0 . . . b31] of register 204 can be allocated to store communications with native GPIO pins and bits [b32 . . . b95] of register 204 can be allocated to store communications with platform GPIO pins, but other bits can be used. The width of the ACPI event/status register 204 can be extended to larger numbers of native and platform GPIO pins. This architecture is flexible to support additional families of GPIOs. For example, if a GPIO pin is hosted on an SMBus interface, then such GPIO pin can also be supported via the ACPI infrastructure.

System 200 can be implemented as one or more of: system on chip (SoC) or a physical package that includes one or more discrete dies or tiles connected by mesh or other connectivity as well as an interface (not shown) and heat dispersion (not shown). A die can include semiconductor devices that include one or more processing devices or other circuitry. A tile can include semiconductor devices that include one or more processing devices or other circuitry. For example, a physical package can include one or more dies, plastic or ceramic housing for the dies, and conductive contacts conductively coupled to a circuit board.

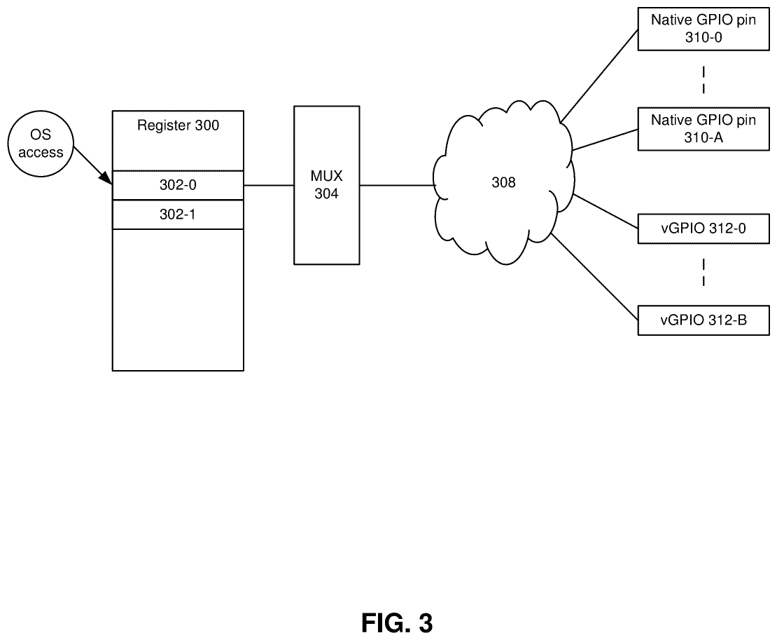

FIG. 3 depicts an example of access to a register for communications with native and platform GPIO pins. Register 300 can be configured in a manner consistent with section 4.8.4.1.1 General-Purpose Event 0 Register Block of UEFI Forum, Inc., “Advanced Configuration and Power Interface (ACPI) Specification,” Release 6.5 (2022). For example, one or more bits of regions 302-0, 302-1, and so forth can be allocated to one or more of native GPIO pins 310-0 to 310-A and/or one or more of virtual GPIO (vGPIO) pins 312-0 to 312-B, where A and B are integers. vGPIO pins 312-0 to 312-B can transmit or receive communications multiplexed by extender 230 so that X number of GPIO pads 212 can receive or transmit packets using X+Y number of platform GPIO pins, where X and Y are integers. In some examples, a number of vGPIO pins can equal or exceed a number of platform GPIO pins 214.

For example, GPE status (GPE_STS) regions 302-0, 302-1, and so forth can be allocated in register 300 to store communications (e.g., read, write, event) to or from one or more of native GPIO pins 310-0 to 310-A and/or one or more of virtual GPIO pins 312-0 to 312-B. An operating system (OS) can access regions 302-0, 302-1, etc. to access received communications or to write communications that are to be transmitted via GPIO pins.

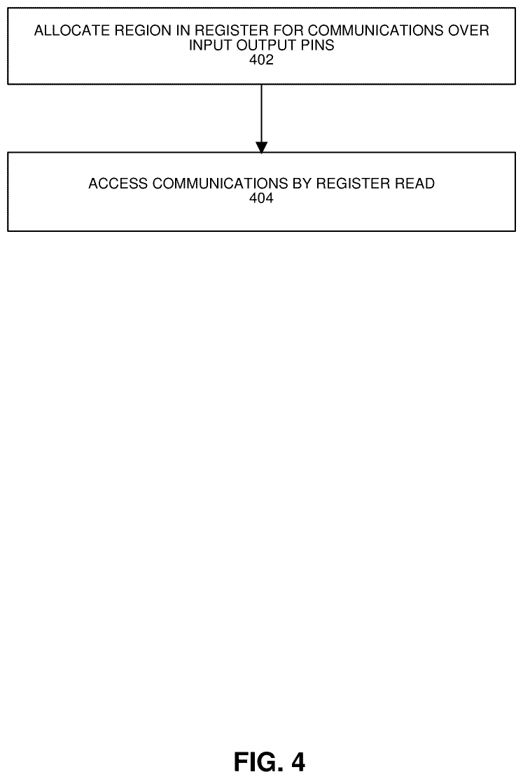

FIG. 4 depicts an example process. The process can be performed by a processor, such as a bootable processor that includes circuitry to access boot firmware. At 402, at least one region in a register accessible to the processor can be allocated to communications received or transmitted over a first and second set of input output pins. The first set of input output pins can be associated with native GPIO pins whereas the second set of input output pins can be associated with platform GPIO pins. In some examples, a first region (e.g., bit positions) in the register can be allocated for communications involving the first set of input output pins. In some examples, a second region (e.g., bit positions) in the register can be allocated for communications involving the second set of input output pins. In some examples, a boot firmware can allocate the first and second regions in the register at boot of a bootable processor or reset of the bootable processor. In some examples, the register can be configured in accordance with ACPI.

At 404, an OS can access or issue communications with first and second sets of input output pins by reading or writing to a register. For example, by accessing a first region in the register, communications can be accessed to or from the first set of input output pins. For example, by accessing a second region in the register, communications can be accessed to or from the second set of input output pins. In some examples, communications can include read, write, or event status. For example, a read command can access data at a particular memory address or register. For example, a write command can write data to a particular memory address or register. For example, an event status can write a particular event (e.g., plug event, fault condition, light emitting diode (LED) status, or others) to a particular memory address or register.

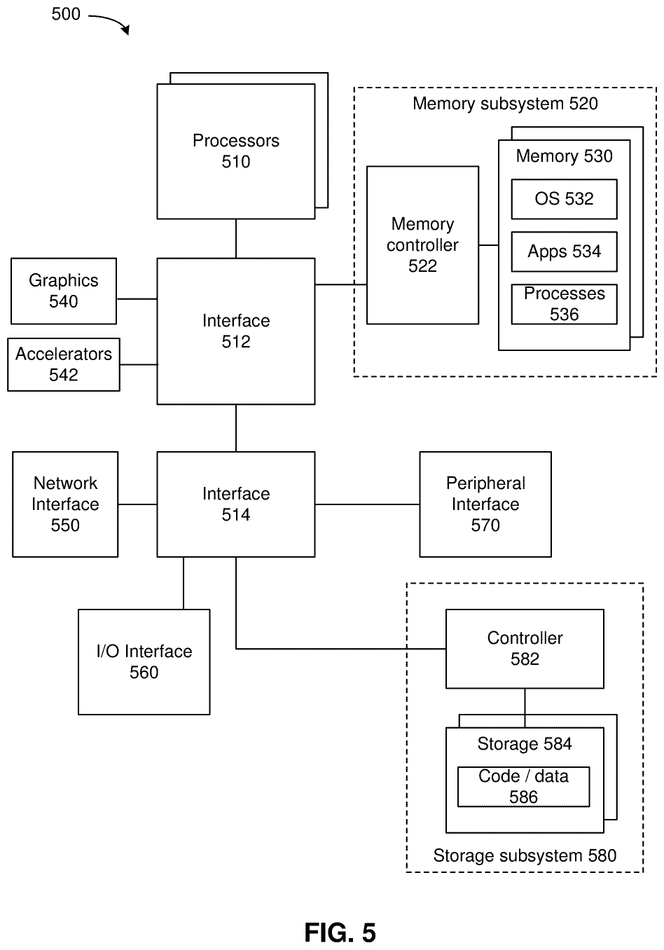

FIG. 5 depicts a system. In some examples, circuitry of system 500 can be configured to increase a number of input output pins of a bootable processor by use of an IO extender and allocation of a register to store communications, as described herein. System 500 includes processor 510, which provides processing, operation management, and execution of instructions for system 500. Processor 510 can include any type of microprocessor, central processing unit (CPU), bootable CPU, graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 510 can include multiple processors and multiple processors can be embodied as processor sockets.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, authentication, trust verification, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510. For example, memory controller 522 can be configured to adjust a size of a table indicative of locations of boot firmware and selectively permit access to the table

Applications 534 and/or processes 536 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, or compatible with reduced instruction set computer (RISC) instruction set architecture (ISA) (e.g., RISC-V), among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, packet processing device or network interface device 550 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 500 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 500 can be implemented using interconnected compute platforms of processors, memories, storages, network interfaces, and other components. High speed interconnects can be used such as PCle, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

An example includes circuitry connected to a processor, wherein the circuitry is to: adjust an address decode value via fuses and straps to set a decode window to an particular size. A firmware can program decoders and the boot logic to cover a programmed range.

Example 1 includes one or more examples and includes at least one non-transitory computer-readable medium comprising instructions stored thereon, that if executed by one or more processors, cause the one or more processors to: for a bootable processor that includes circuitry to perform a boot operation, allocate memory address space to provide access to communications over general purpose input output (GPIO)-consistent pins, wherein: the GPIO-consistent pins comprise pins coupled to the bootable processor and a pin of the pins coupled to the bootable processor receives or transmits communication for multiple platform GPIO pins.

Example 2 includes one or more examples, wherein: the communications over GPIO-consistent pins are accessible in at least one register by a processor-executed Advanced Configuration and Power Interface (ACPI)-consistent driver.

Example 3 includes one or more examples, wherein: the communications over GPIO-consistent pins comprise one or more of: read, write, status, or event.

Example 4 includes one or more examples, wherein: a first range of event and status indications in a register is allocated to the pins coupled to the bootable processor and a second range of event and status indications in the register associated with the memory address space is allocated to the multiple platform GPIO pins.

Example 5 includes one or more examples, wherein: the pin of the pins coupled to the bootable processor provides communication for multiple platform GPIO pins by time division multiplexing of communications.

Example 6 includes one or more examples, wherein: the pin of the pins coupled to the bootable processor provides virtual Enhanced Serial Peripheral Interface (eSPI) wires.

Example 7 includes one or more examples, wherein: the pin of the pins receives or transmits time division multiplexed communications for multiple platform GPIO pins.

Example 8 includes one or more examples, wherein: the pin of the pins receives or transmits time division multiplexed communications for multiple platform GPIO pins by communication with an input output (IO) expander.

Example 9 includes one or more examples and an apparatus that includes: a bootable processor that includes circuitry to perform a boot operation and includes: a second circuitry comprising a first interface, wherein the first interface comprises N pins and is to receive communications over N*M pins and provide communications to the N*M pins, N comprises a non-zero integer, M comprises a non-zero integer, the first interface is consistent with general purpose input output (GPIO), and the communications over the N*M pins are time division multiplexed among the N pins.

Example 10 includes one or more examples, wherein: the N*M pins comprise N*M virtualized Enhanced Serial Peripheral Interface (eSPI) wires.

Example 11 includes one or more examples and includes a third circuitry to multiplex the communications over the N+M pins and provide the multiplexed communications to the first interface.

Example 12 includes one or more examples, wherein: the communications comprise one or more of: GPIO-consistent read, GPIO-consistent write, or GPIO-consistent event.

Example 13 includes one or more examples and includes a register, wherein: access to the communications is based on access to the register and the register is allocated for access by a processor-executed Advanced Configuration and Power Interface (ACPI)-consistent driver.

Example 14 includes one or more examples and includes a method that includes: a bootable processor that includes boot circuitry performing: receiving and transmitting communications over a first set of general purpose input output (GPIO)-consistent pins; and receiving and transmitting communications over a second set of GPIO-consistent pins, wherein: a single pin of the second set of GPIO-consistent pins receives or provides communication for multiple platform GPIO pins.

Example 15 includes one or more examples and includes allocating regions for the communications over the first and second set of GPIO-consistent pins in at least one register.

Example 16 includes one or more examples and includes a processor-executed Advanced Configuration and Power Interface (ACPI)-consistent driver accessing the communications over the first and second set of GPIO-consistent pins in a register.

Example 17 includes one or more examples, wherein: the communications over GPIO-consistent pins comprise one or more of: read, write, status, or event.

Example 18 includes one or more examples, wherein: a first range of event and status indications in a register is allocated to the first set of GPIO-consistent pins and a second range of event and status indications in the register is allocated to the second set of GPIO-consistent pins.

Example 19 includes one or more examples, wherein: the single pin of the second set of GPIO-consistent pins provides receives or transmits for multiple platform GPIO pins by time division multiplexing of communications.

Example 20 includes one or more examples, wherein: the single pin of the second set of GPIO-consistent pins receives or transmits communication for multiple platform GPIO pins by communication over virtual Enhanced Serial Peripheral Interface (eSPI) wires.

1. At least one non-transitory computer-readable medium comprising instructions stored thereon, that if executed by one or more processors, cause the one or more processors to:
for a bootable processor that comprises circuitry to load boot firmware, allocate memory address space to provide access to communications over general purpose input output (GPIO)-consistent pins, wherein:
the GPIO-consistent pins comprise pins coupled to the bootable processor and
a pin of the pins coupled to the bootable processor receives or transmits communication for multiple platform GPIO pins.

2. The computer-readable medium of claim 1, wherein:
the communications over GPIO-consistent pins are accessible in at least one register by a processor-executed Advanced Configuration and Power Interface (ACPI)-consistent driver.

3. The computer-readable medium of claim 1, wherein:
the communications over GPIO-consistent pins comprise one or more of: read, write, status, or event.

4. The computer-readable medium of claim 1, wherein:
a first range of event and status indications in a register is allocated to the pins coupled to the bootable processor and
a second range of event and status indications in the register associated with the memory address space is allocated to the multiple platform GPIO pins.

5. The computer-readable medium of claim 1, wherein:
the pin of the pins coupled to the bootable processor provides communication for multiple platform GPIO pins by time division multiplexing of communications.

6. The computer-readable medium of claim 1, wherein:
the pin of the pins coupled to the bootable processor provides virtual Enhanced Serial Peripheral Interface (eSPI) wires.

7. The computer-readable medium of claim 1, wherein:
the pin of the pins receives or transmits time division multiplexed communications for multiple platform GPIO pins.

8. The computer-readable medium of claim 1, wherein:
the pin of the pins receives or transmits time division multiplexed communications for multiple platform GPIO pins by communication with an input output (IO) expander.

9. An apparatus comprising:
a bootable processor that comprises first circuitry to perform a boot operation comprising:
a second circuitry comprising a first interface, wherein
the first interface comprises N pins and is to receive communications over N*M pins and provide communications to the N*M pins,
N comprises a non-zero integer,
M comprises a non-zero integer,
the first interface is consistent with general purpose input output (GPIO), and
the communications over the N*M pins are time division multiplexed among the N pins.

10. The apparatus of claim 9, wherein:
the N*M pins comprise N*M virtualized Enhanced Serial Peripheral Interface (eSPI) wires.

11. The apparatus of claim 9, comprising:
a third circuitry to multiplex the communications over the N+M pins and provide the multiplexed communications to the first interface.

12. The apparatus of claim 11, wherein:
the communications comprise one or more of: GPIO-consistent read, GPIO-consistent write, or GPIO-consistent event.

13. The apparatus of claim 9, comprising a register, wherein:
access to the communications is based on access to the register and
the register is allocated for access by a processor-executed Advanced Configuration and Power Interface (ACPI)-consistent driver.

14. A method comprising:
a bootable processor that includes boot circuitry, the bootable processor performing:
receiving and transmitting communications over a first set of general purpose input output (GPIO)-consistent pins; and
receiving and transmitting communications over a second set of GPIO-consistent pins, wherein:
a single pin of the second set of GPIO-consistent pins receives or provides communication for multiple platform GPIO pins.

15. The method of claim 14, comprising:
allocating regions for the communications over the first and second set of GPIO-consistent pins in at least one register.

16. The method of claim 14, comprising:
a processor-executed Advanced Configuration and Power Interface (ACPI)-consistent driver accessing the communications over the first and second set of GPIO-consistent pins in a register.

17. The method of claim 14, wherein:
the communications over GPIO-consistent pins comprise one or more of: read, write, status, or event.

18. The method of claim 14, wherein:
a first range of event and status indications in a register is allocated to the first set of GPIO-consistent pins and
a second range of event and status indications in the register is allocated to the second set of GPIO-consistent pins.

19. The method of claim 14, wherein:
the single pin of the second set of GPIO-consistent pins provides receives or transmits for multiple platform GPIO pins by time division multiplexing of communications.

20. The method of claim 14, wherein:
the single pin of the second set of GPIO-consistent pins receives or transmits communication for multiple platform GPIO pins by communication over virtual Enhanced Serial Peripheral Interface (eSPI) wires.
